(19) United States
(12) Patent Application Publication
(10) Pub. No.: US 2009/0283403 A1
(43) Pub. Date: Nov. 19, 2009

(54) Sensor element having improved dynamic properties

(76) Inventors: Joerg Ziegler, Rutesheim (DE); Thomas Classen, Stuttgart (DE)

Correspondence Address: KENYON & KENYON LLP, ONE BROADWAY, NEW YORK, NY, 10004, US

(21) Appl. No.: 12/387,109

(22) Filed: Apr. 27, 2009

(30) Foreign Application Priority Data
May 15, 2008 (DE) 10 2008023 695.0

(51) Int. Cl. G01N 27/26

(52) U.S. Cl. 204/424

(57) ABSTRACT

A sensor element, e.g., for measuring an oxygen concentration in an exhaust gas, has at least two electrodes and at least one solid electrolyte connecting the electrodes. The solid electrolyte has at least one first metal oxide as the solid electrolyte matrix material, and at least one solid electrolyte dopant. At least one intermediate layer is situated between at least one of the electrodes and the solid electrolyte. The intermediate layer has at least one second metal oxide as the intermediate layer matrix material and at least one intermediate layer dopant. The concentration of the intermediate layer dopant in the intermediate layer matrix material is less than the concentration of the solid electrolyte dopant in the solid electrolyte matrix material.

### BACKGROUND OF THE INVENTION

1. Field of the Invention

The present invention relates to sensor elements that are based on electrolytic properties of certain solids, i.e., the capability of these solids of conducting certain ions.

2. Description of Related Art

Sensor elements based on electrolytic properties are used particularly in motor vehicles for measuring air/fuel gas mixture compositions. In particular, sensor elements of this type are used in so-called “lambda probes,” and they play an important part in the reduction of pollutants in exhaust gases, both in Otto engines and in Diesel technology. The present invention is also applicable, however, to other types of sensor elements, which include solid electrolytes, that is, besides voltage-jump sensors and wide range lambda sensors also to particle sensors, for instance, or similar types of sensors having solid electrolytes, for example, and also for measuring CO, NOₓ or NH₃. Without restriction of protection, the present invention is explained below using the example of lambda probes, but, in light of the above statements, other types of elements are also able to be produced, for instance, sensor elements for determining the concentration of other gas components, such as oxygen-containing components.

In combustion technology, the so-called air ratio “lambda” (λ) generally denotes the ratio of an actually supplied air mass to the air mass required theoretically (i.e., stoichio-metrically). The air ratio is measured, in this context, using one or more sensor elements mostly at one or more locations in the exhaust tract of an internal combustion engine. Correspondingly, “rich” gas mixtures (i.e. gas mixtures having an excess in fuel) have an air ratio λ<1, whereas “lean” gas mixtures (i.e. gas mixtures having a fuel deficiency) have an air ratio λ>1. Besides in motor vehicle technology, such and similar sensor elements are also used in other fields of technology (especially in combustion technology), such as in aviation technology or in the control of burners, for instance, in heating systems or power stations.

Lambda probes are known in a wide variety of embodiments. A first specific embodiment represents the so-called “voltage-jump sensor,” whose measuring principle is based on the measurement of an electrochemical potential difference between a reference gas and the gas mixture that is to be measured. The reference electrode and the measuring electrode are connected to each other via solid electrolytes. As the solid electrolyte, zirconium dioxide (for instance, yttrium-stabilized zirconium dioxide, YSZ) or similar ceramics are used, as a rule, based on its good oxygen ion-conducting properties. Alternatively or in addition to voltage-jump sensors, so-called “pump cells” are also used, in which an electrical “pumping voltage” is applied to two electrodes connected via the solid electrolyte, the “pumping current” being measured by the pump cell. The sensor principles described for voltage-jump cells and pumping cells may advantageously also be used in combination, in so-called “multicell units”. Pumping cells and multicell units are used particularly as so-called broadband probes, that is, as probes which are not only able to be used in the range of λ=1, but also in other air ratio ranges. Examples of such broadband probes and their operating manner are described in Robert Bosch GmbH, Sensors in the Motor Vehicle, 1^{st} Edition, June 2001, p. 116-117.

One problem with known lambda probes is that engine exhaust gases typically have pressure fluctuations, which have an influence on the sensor signal, and with that, on the lambda value ascertained. This is a so-called dynamic pressure dependence (DPD) of the sensor element. This signal interference should be as slight as possible. The variable DPD is usually characterized by pressure surges having a pressure amplitude Δp_{SS} and a specified frequency, the composition of the gas remaining constant and only the partial pressure of the oxygen, and with that, also pump current Iₚ, changing as a result of the pressure fluctuations. The dynamic pressure dependence DPD is defined as

$$D D A = \frac{Δ {I}_{pss}}{{I}_{paverage} \cdot Δ {p}_{ss}} \cdot 100 [ \% / bar ] \qquad ( 1 )$$

where Δp_{SS} designates the maximum pumping current difference in response to the pressure surges and I_{paverage} designates the average pumping current.

In many known sensor elements, the improvement of the dynamic pressure dependence represents a challenge, since it influences the accuracy of the probe during pressure fluctuations such as occur in engine operation. To be sure, a number of known measures exist for improving the dynamic pressure dependence, consisting, for instance, of a damping of the pressure pulses by a tighter diffusion barrier or a change in the electrode composition. However, because of these measures, the dynamics of the sensor element, that is, the response time of the sensor element to a gas change is influenced at the same time, as a rule. This variable is, however, also meaningful, since it ensures the individual cylinder regulation capability of the sensor element. A rise in the response time can only be tolerated within very tight limits.

### BRIEF SUMMARY OF THE INVENTION

The sensor element according to the present invention largely avoids the disadvantages of known sensor elements by providing an improved dynamic pressure dependence at a substantially unchanged response time.

The present invention is based on the surprising realization that one is able to improve significantly the dynamic pressure dependence by using certain intermediate layers between the actual electrodes and the solid electrolyte. Accordingly, a sensor element is provided for measuring at least one physical property in a measuring gas chamber, which may be designed according to the related art described above. The sensor element may particularly be a sensor element for measuring the concentration (i.e. the proportion and/or the partial pressure) of a gas component in a gas in a measuring gas chamber, especially for measuring the oxygen concentration in an exhaust gas. The sensor element has at least two electrodes and at least one solid electrolyte connecting the electrodes. The solid electrolyte, in turn, has at least one first metal oxide as the solid electrolyte matrix material, and at least one solid electrolyte dopant. By dopant one should understand, in this connection, a substance which acts in the metal oxide of the solid electrolyte matrix material to bring about the conductivity for ions of the gas component that is to be identified. In particular, the dopant may be a material that may be incorporated into lattice sites of the metal oxide instead of the metal ions of the metal oxide, and which, based on a valence that is different from that of the metal of the metal oxide, causes oxygen lattice defects which, for example, give rise to oxygen ion conductivity. If the metal of the metal oxide has a predetermined valence, for example, (as zirconium, for instance) a valence of 4, the solid electrolyte dopant may include a metal, for example, which has a lesser valence than 4, for instance, a valence of 2 or 3.

In the sensor element provided, at least one of the electrodes between the actual electrode, which is able to include at least one conductive electrode layer, and the solid electrolyte, has at least one intermediate layer. This intermediate layer is designed in such a way, in this context, that it has at least one second metal oxide as intermediate layer matrix material and an intermediate layer dopant. The second metal oxide is preferably at least partially identical to the first metal oxide. The solid electrolyte matrix material and the intermediate layer matrix material, thus, are able to be completely or partially identical in material, i.e. they may have the same material. In particular, the solid electrolyte matrix material and the intermediate layer matrix material may include a zirconium oxide, especially zirconium dioxide.

The intermediate layer dopant, with the term “dopant” corresponding to the above definition, has a lower concentration in the intermediate layer matrix material, in this instance, than the concentration of the solid electrolyte dopant in the solid electrolyte matrix material. In other words, it is provided that one should insert a lower doped intermediate layer between the conductive electrode and the solid electrolyte. It has been shown that such an intermediate layer is clearly able to reduce the dynamic pressure dependence.

The solid electrolyte dopant and the intermediate layer dopant may also be wholly or partially identical. The solid electrolyte dopant may include yttrium oxide, for example, especially Y₂O₃. The intermediate layer dopant may preferably include a 2- or a 3-valent dopant, especially in the case of a 4-valent solid electrolyte matrix material, such as zirconium oxide. Especially preferred is the use of at least one of the following materials, particularly in the form of an oxide: scandium, especially Sc₂O₃, erbium, ytterbium, yttrium, calcium, lanthanum, gadolinium, europium, and dysprosium. The use of Sc₂O₃ is particularly preferred, since scandium-doped matrix materials, particularly Sc-doped ZrO₂, have a high ionic conductivity, for instance, a higher ionic conductivity than yttrium-doped ZrO₂. This being the case, the doping concentration can be lowered without thereby losing significant conductivity. The intermediate layer dopant preferably has a concentration in the range of between 2 mol % and 10 mol %, especially in the range of between 2 and 5 mol %. The concentration of the solid electrolyte dopant is preferably in the range between 5 and 10 mol %.

The conductive electrode layer may have a noble metal, particularly platinum. The conductive electrode layer may, for instance, include a cermet layer. The cermet is able to ensure the binding of the electronic conductivity of the metal to the ionic conductivity of the metal oxide. However, the intermediate layer is preferably free or at least essentially free of noble metal.

The intermediate layer preferably has a thickness in the range between 5 and 20 μm, particularly a thickness in the range of ca. 10 μm. At these intermediate layer thicknesses, one is able experimentally to confirm the effect of the reduction of the dynamic pressure dependence in an especially pronounced manner. However, other thicknesses are basically also possible.

Besides the intermediate layer matrix material and the intermediate layer dopant, the intermediate layer is able to include at least one further additive material that does not substantially influence the doping, which is thus not to be classified as a dopant within the meaning of the above definition. This additive material may include, for instance, at least one of the following materials: hafnium oxide (especially HfO₂), silicon oxide (especially SiO₂), aluminum oxide (especially Al₂O₃), sodium, potassium. In general, substances may be used which aid mechanical stabilization or are contained as a trace element. The additive substance in the intermediate layer may have a concentration in the range between 0 and 10 mol %, for example.

Further advantageous embodiments of the present invention relate to the construction and the operation of the sensor element. Thus, for instance, the second electrode may at least partially be situated in at least one electrode cavity, the electrode cavity being able to have a gas from the measuring gas applied to it via at least one diffusion barrier. In this case, the sensor element may correspond to the usual broadband sensor elements, for example. In this case the second electrode is preferably used as an insertion electrode, that is, as an electrode on which the ions of the gas component to be identified are inserted into the solid electrolyte, that is, as an oxygen ion insertion electrode, for instance. For this purpose, a sensor device having the sensor element may be provided which, in addition, includes at least one controller that is devised so as to connect the sensor element corresponding to this operating manner. In this case, the at least one intermediate layer is situated between the at least one second electrode and the solid electrolyte.

Furthermore, the first electrode and the second electrode may be situated in the same layer plane. It is, however, particularly preferred if the second electrode is situated in a lower layer of the sensor element. Thus, the first electrode and the second electrode may form, for instance, at least one pump cell in common with the solid electrolyte, having an inner pumping electrode and an outer pumping electrode. As was described above, the inner pumping electrode is preferably connected as an insertion electrode or an anode, in this context.

The provided sensor element is particularly able to be used within the scope of a broadband lambda probe, and is able to be utilized to improve considerably dynamic pressure dependence, and thus the accuracy of the sensor element or sensor system. By contrast to known measures, this improvement has no, or only slight effects on other functional variables of the sensor element or sensor system.

### BRIEF DESCRIPTION OF SEVERAL VIEWS OF THE DRAWING

FIG. 1 shows a schematic exemplary embodiment of a standard broadband probe.

FIG. 2 shows an improved electrode as inner pump electrode for the sensor element according to the present invention.

FIGS. 3A and 3B show the dependence of pumping current Iₚ (FIG. 3B) on pressure fluctuations (FIG. 3A) for illustrating the dynamic pressure dependence.

### DETAILED DESCRIPTION OF THE INVENTION

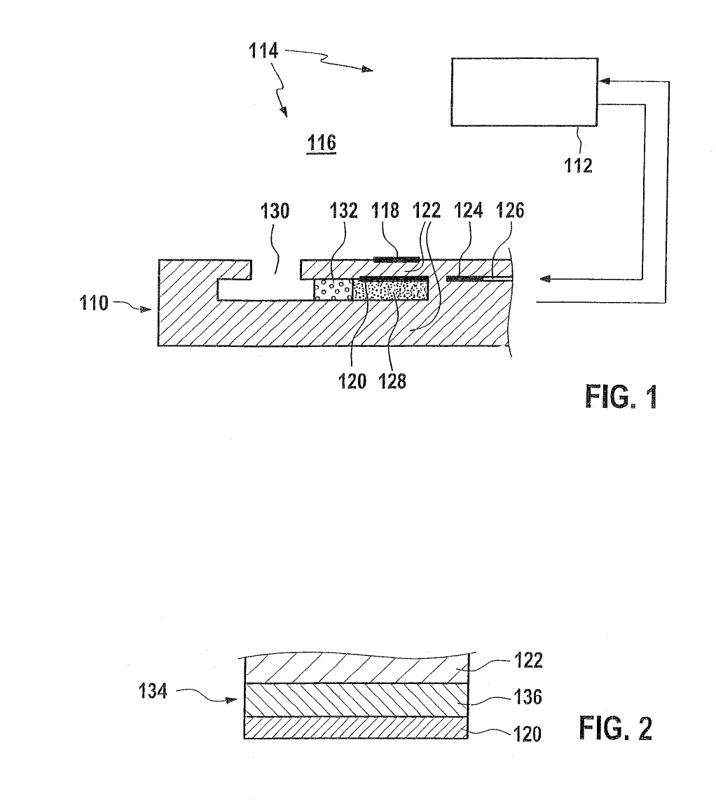

FIG. 1 shows a sensor element 110 corresponding to the related art, which is modified to achieve the sensor element according to the present invention. However, the present invention may also be applied to other types of sensor elements 110. Sensor element 110 may, for instance, be used in common with a controller 112 which may be integrated, completely or partially, into a central engine control unit. Controller 112 and sensor element 110 together then form a sensor system 114. Such sensor elements 110 and sensor systems 114 may be used, for example, to ascertain an oxygen concentration or a partial oxygen pressure in a measuring gas chamber 116.

In the exemplary embodiment shown in FIG. 1, sensor element 110 is a planar broadband lambda probe, which is frequently also denoted as an LPU (lambda probe universal). The operating manners of sensor element 110 and sensor system 114 are described in Robert Bosch GmbH, Sensors in the Motor Vehicle, 1^{st} Edition, June 2001, pp. 116 to 117, for example. An exemplary design of a simple controller 112 is also shown there.

In the exemplary embodiment shown, sensor element 110 has a first electrode 118, a second electrode 120 and a solid electrolyte 122 that connects electrodes 118, 120. Solid electrolyte 122 may include yttrium-stabilized zirconium dioxide, for example. Furthermore, a reference electrode 124 is provided, which is situated in a reference air channel 126. Reference air channel 126, which may be filled, for instance, with a porous material (aluminum oxide, for example), is connected to a reference gas chamber, for instance, the engine chamber of an internal combustion engine, whereas measuring gas chamber 116 is able to include the inner space of an exhaust tract of the internal combustion engine. Moreover, a heating element may be provided for holding sensor element 110 to an operating temperature.

Whereas in the exemplary embodiment of sensor element 110, shown in FIG. 1, first electrode 118 is situated on the side of sensor element 110 facing measuring gas chamber 116, and, for instance, is separated from measuring gas chamber 116 only by a thin, gas-permeable protective layer (for instance, again a porous aluminum layer), second electrode 120 is situated on the inside of sensor element 110 in an electrode cavity 128. This electrode cavity 128 may, in turn, be completely empty or may be filled with a gas-permeable porous material, such as aluminum oxide. Electrode cavity 128 may have applied to it gas from measuring gas chamber 116, via a gas access hole 130 and a diffusion barrier 132. Diffusion barrier 132, which may include a finely porous ceramic material, borders on the wake of the gas from measuring gas chamber 116 into electrode cavity 128, and thereby determines the limiting current of sensor element 110.

In FIG. 1, sensor element 110 designed as an “LPU” is an amperometric limiting current probe, based on ceramic solid electrolyte 122. First electrode 118 is also denoted frequently as outer pump electrode OPE, in this context, and second electrode 120 as inner pump electrode IPE. With the aid of a control circuit in controller 112, the oxygen concentration in electrode cavity 128 is able to be held constant. In this circuit, inner pump electrode 120 pumps off O₂ from electrode cavity 128 when there is an oxygen excess, and develops O₂ when there is a shortage of oxygen. Outer pump electrode 118 is used as the counter-electrode. The current at electrodes 118, 120 is a measure for the O₂ concentration or the lack of O₂ in the exhaust gas in measuring gas chamber 116. The partial oxygen pressure in electrode cavity 128 is measured by using second electrode 120 and reference electrode 124 together with solid electrolyte 122 as a Nernst cell. The partial oxygen pressure is then able to be measured using the voltage between second electrode 120 (Nernst electrode) within electrode cavity 128 and reference electrode 124, reference air channel 126 having a known oxygen concentration. In the exemplary embodiment shown in FIG. 1, this is the oxygen concentration of the environmental air. Alternatively or in addition, another type of reference gas chamber is possible, however.

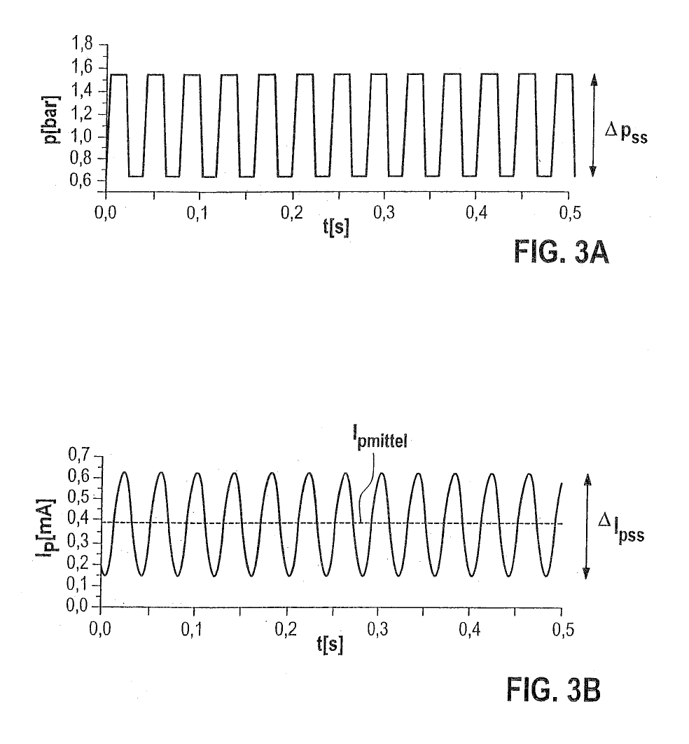

The problem of sensor elements 110 that correspond to the related art, as shown in FIG. 1, will now be explained with the aid of FIGS. 3A and 3B. Thus, the engine exhaust gas in measuring gas chamber 116 demonstrates pressure fluctuations, which have an influence on the sensor signal, and thus also on the lambda value ascertained. As was described above, this influence is designated as the dynamic pressure dependence (DPD) of sensor element 110, which was defined above by Formula (1).

FIG. 3A shows an exemplary curve of pressure pulsations of an overall pressure p of the gas in measuring gas chamber 116. The pressure pulsations have an amplitude (here peak to peak) of Δp_{SS}. The pressure curve shown in FIG. 3A, given in bar, may be artificially influenced, for instance, in such a way that it has the curve over time shown in FIG. 3A. FIG. 3B shows a response signal of sensor element 110 or sensor system 114 to the pressure curve shown in FIG. 3A, also again of a function of time t in seconds. What is plotted there is pumping current Iₚ in mA measured between electrodes 118, 120. Correspondingly to the pressure pulsations in FIG. 3A, the sensor signal or the pumping current in FIG. 3B also shows a periodic curve, although the composition of the gas remains constant and only the partial pressure of the oxygen, and with that, also the pumping current, changes. The average pumping current I_{paverage} is entered on FIG. 3B as a dashed line. Furthermore, the pressure surge amplitude (again given peak to peak) Δp_{SS} is shown. This makes it clear that, in spite of the constant exhaust gas composition, the signal of sensor system 114 may be submitted to considerable fluctuations, which are able to impair greatly the capability to use sensor element 110 or sensor system 114.

FIG. 2 shows an electrode system 134, using which, sensor element 110 shown in FIG. 1 is able to be modified and implemented according to the present invention. Accordingly, some portions of the above description for sensor element 110 and the sensor system 114 may apply equally to the exemplary embodiment of the sensor according to the present invention. Electrode system 134 may, for instance, be used as replacement for second electrode 120, i.e., instead of the inner pumping electrode. Alternatively or in addition, further electrodes may, however, be modified according to the present invention, or other types of structures of sensor element 110 may be used. The use of the invention is basically possible for all broadband lambda probes for the purpose of improving the DPD and, with that, the accuracy, without having to influence other functional variables substantially. Let us assume below that electrode system 134 relates to second electrode 120. Second electrode 120, and first electrode 118 as well, may include a platinum electrode, for example. Second electrode 120 may, for instance, be produced by appropriate printing (e.g. by silk-screen printing) of platinum pastes on solid electrolyte 122. Second electrode 120 may also include an electrode matrix material, for instance, again zirconium dioxide and an electrode dopant within the meaning of the above definition.

Between second electrode 120 and solid electrolyte 122, an intermediate layer 136 is incorporated, according to the present invention, for instance, by first printing intermediate layer 136 onto solid electrolyte 122, in order then to print the paste of second electrode 120 onto intermediate layer 136. Intermediate layer 136 preferably does not contain any noble metal, and thus it has no, or rather only a slight electron conductivity, in contrast to the material of second electrode 120.

Compared to solid electrolyte 122 and preferably also compared to second electrode 120, intermediate layer 136 has a lesser dopant concentration. Examples of a composition are shown in Table 1.

TABLE 1
Exemplary composition of a preferred electrode system
(data given in mol %).

| | | | Additive | Noble | Matrix |
|---|---|---|---|---|---|
| | Dopant | | substance | metal | material |
| | Y₂O₃ | Sc₂O₃ | Al₂O₃ | Pt | ZrO₂ |
| Solid | 5-10 | — | 0-10 | — | residue |
| electrolyte | | | | | |
| Intermediate | — | 2-5 | 0-10 | — | residue |
| layer | | | | | |
| Second | 5-10 | — | 0-10 | Yes | residue |
| electrode | | | | | |

In Table 1 the concentrations of the materials are given in mol % for solid electrolyte 122, intermediate layer 136 and for second electrode 120, in this context. In the example shown, zirconium dioxide is used as the matrix material, to which may be added Al₂O₃ as inactive material, as an additive at a certain concentration, if necessary. The matrix materials for solid electrolyte 122, intermediate layer 136 and second electrode 120 are thus the same in the exemplary embodiment shown, but they may also be different.

Y₂0₃ is used as dopant for solid electrolyte 122 and second electrode 120, respectively. As was stated above, trivalent yttrium is involved in this instance, which is able to be incorporated into the lattice sites of the zirconium dioxide, and is thereby able to produce lattice vacancy sites. These lattice vacancy sites ensure the conductivity for oxygen ions.

In the exemplary embodiment, the intermediate layer dopant is Sc₂0₃. The concentration of the dopant may generally move in the range between 2 and 10 mol %, however, concentrations in the range between 2 and 5 mol % are preferred. In each case, however, the dopant concentration of intermediate layer 136 is less than the dopant concentration of solid electrolyte 122 and preferably also of second electrode 120.

In the exemplary embodiment shown, the second electrode contains platinum as the noble metal, whereas intermediate layer 136 and solid electrolyte 122 are not supposed to contain any noble metal. Intermediate layer 136 preferably has a thickness of ca. 10 μm, while second electrode 120 is able to have a thickness of 5-20 μm, for example. Intermediate layer 136 may be applied in a silk-screen printing method, for instance. Scandium is used as the preferred doping atom for intermediate layer 136, since scandium has a higher oxygen ion conductivity than yttrium. Using scandium doping of 3.2 mol %, approximately the same conductivity is achieved as when using ca. 5 mol % yttrium. This ensures that the intermediate layer is doped less, to be sure, without reducing the conductivity in this instance, which would, in turn, have a negative effect on the resistance of the pumping cell formed by the two electrodes 118, 120, and solid electrolyte 122. In selecting the scandium doping, one should observe that the doping has to be high enough to still produce a stabilized (tetragonal or cubic) zirconium dioxide. As the dopant concentration of the intermediate layer increases, the effect of the lessening of the dynamic pressure dependence is gradually reduced. One could also use erbium or ytterbium, for example, instead of scandium, but the effect would be less. In principle, intermediate layer 136 could also be doped with yttrium, calcium, lanthanum, gadolinium, europium or dysprosium. However, in that case, an equally great or greater pumping cell resistance will be observed at a reduced dopant concentration, in comparison to solid electrolyte 122 and possibly also to second electrode 120. This causes the pumping voltage to rise, which is required to achieve the limiting current.

Additives which are not taken into account in Table 1 may furthermore be included in all layers. These additive substances may include HfO₂, SiO₂, Al₂O₃, Na, K or similar substances.

Table 2 lists exemplary measurements of functional properties of a sensor element having a scandium doping of 3.2 mol % in intermediate layer 136, at an intermediate layer thickness of ca. 10 μm, as compared to a sensor element that does not have this intermediate layer 136.

TABLE 2
Comparison of the properties of sensor elements with
and without intermediate layers.

| | Sensor elements | Sensor element |
|---|---|---|
| | not having an | having an |
| | intermediate layer | intermediate layer |
| Rₚᵤₘₚ [Ω] | 220 ± 20 | 230 ± 10 |
| relative LO time | 100% | 95% ± 5% |
| DPD (25 Hz) [%/bar] | 130 ± 2 | 100 ± 17 |
| DPD (100 Hz) [%/bar] | 17 ± 2 | 7 ± 2 |
| Relative response | 100% | 100% ± 10% |
| Continuous lean | ✓ | ✓ |
| operation | | |
| Continuous air | ✓ | ✓ |
| operation | | |

In this context, Rₚᵤₘₚ denotes the resistance of a pumping cell including electrodes 118, 120 and solid electrolyte 122, given in Ω. As may be seen, the insertion of intermediate layer 136 changes the resistance only slightly. The term “relative LO time” denotes the so-called light-off time, that is, the time within which sensor element 110 and sensor system 114 are ready for operation. The specifications are given with reference to a sensor element not having an intermediate layer, whose light-off time is arbitrarily set to 100%. Here too, it may be seen that intermediate layer 136, or electrode system 134 according to the present invention, influence the properties of sensor element 110 or sensor system 114 not at all, or only insubstantially, within the scope of error limits.

The details of the DPD in Table 2 represent the actually decisive improvements of sensor element 110, according to the present invention, having electrode system 134. Measurements are given at 25 Hz and at 100 Hz. It may be clearly recognized that the use of intermediate layer 136, according to the present invention, lowers the DPD at 25 Hz by ca. 23%, whereas at 100 Hz even a lowering by 59% may be noted.

For the response time of sensor element 110 or sensor system 134 to a gas change, the so-called t₆₃ times are given in this connection in each case, that is, the times within which the signal of sensor element 110 has risen to 63% of its final signal, in response to a gas change. Relative response times are given again in this connection, that is, response times that relate to a sensor element not having an intermediate layer, whose response time was arbitrarily set to 100%. The additional characteristics of continuous lean operation and of continuous air operation denote susceptibilities of sensor element 110 and sensor system 114 with respect to drifts in the operation of sensor element 110 on lean gas. In both cases, no differences could be determined between usual sensor elements 110 and sensor elements 110 according to the present invention, which is characterized in Table 2 by check marks.

One may therefore emphasize as the essential result of the measurements shown in Table 2 that, because of electrode system 134 having intermediate layer 136, the dynamic pressure dependence is able to be lowered significantly. At the same time, however, no significant differences were able to be established in the remaining characteristics variables of sensor element 110 and sensor system 114 within the scope of the standard deviation. Other negative functional effects of intermediate layer 136 could also not be observed. In continuous operation, too, sensor elements 110, according to the present invention, demonstrate comparable properties to the usual sensor elements 110.

What is claimed is:

1. A sensor element for measuring at least one physical property of a gas in a measuring gas chamber, comprising:
at least two electrodes;
at least one solid electrolyte connecting the two electrodes, wherein the solid electrolyte has at least one first metal oxide as a solid electrolyte matrix material and at least one solid electrolyte dopant; and
at least one intermediate layer situated between at least one of the two electrodes and the solid electrolyte, wherein the intermediate layer has at least one second metal oxide as an intermediate layer matrix material and at least one intermediate layer dopant, and wherein the concentration of the intermediate layer dopant is less in the intermediate layer matrix material than the concentration of the solid electrolyte dopant in the solid electrolyte matrix material.

2. The sensor element as recited in claim 1, wherein both the solid electrolyte matrix material and the intermediate layer matrix material include zirconium dioxide.

3. The sensor element as recited in claim 1, wherein the at least one of the two electrodes has an electrode matrix material and an electrode dopant, and wherein the concentration of the intermediate layer dopant in the intermediate layer matrix material is less than the concentration of the electrode dopant in the electrode matrix material.

4. The sensor element as recited in one claim 3, wherein the intermediate layer dopant includes at least one of scandium, Er, Yb, Y, Ca, La, Gd, Eu and Dy.

5. The sensor element as recited in one of claim 3, wherein the intermediate layer dopant has a concentration in the range between 2 mol % and 10 mol %.

6. The sensor element as recited in claim 3, wherein the solid electrolyte dopant has a concentration in the range between 5 and 10 mol %.

7. The sensor element as recited in claim 3, wherein the at least one of the two electrodes has a noble metal, and wherein the intermediate layer is substantially free of noble metal.

8. The sensor element as recited in claim 3, wherein the intermediate layer has a thickness in the range between 5 and 20 micrometers.

9. The sensor element as recited in claim 3, wherein the intermediate layer includes an additive substance having at least one of HfO₂, SiO₂, Al₂O₃, Na and K.

10. The sensor element as recited in claim 9, wherein the additive substance has a concentration in the range between 0 and 10 mol %.

11. The sensor element as recited in claim 3, wherein the at least one of the two electrodes is at least partially situated in at least one electrode cavity, wherein the gas from the measuring gas chamber is applied to the electrode cavity via at least one diffusion barrier.

12. The sensor element as recited in claim 3, wherein the two electrodes are situated in different layer planes of the sensor element.

13. A sensor system, comprising:
a sensor element for measuring at least one physical property of a gas in a measuring gas chamber, the sensor system including:
at least two electrodes;
at least one solid electrolyte connecting the two electrodes, wherein the solid electrolyte has at least one first metal oxide as a solid electrolyte matrix material and at least one solid electrolyte dopant; and
at least one intermediate layer situated between at least one of the two electrodes and the solid electrolyte, wherein the intermediate layer has at least one second metal oxide as an intermediate layer matrix material and at least one intermediate layer dopant, and wherein the concentration of the intermediate layer dopant is less in the intermediate layer matrix material than the concentration of the solid electrolyte dopant in the solid electrolyte matrix material; and
at least one controller;
wherein the sensor system is configured to operate the sensor element as a broadband probe, and wherein the at least one physical property of the gas is determined based on a pumping current between the two electrodes.
